(19) United States
(12) Patent Application Publication
(10) Pub. No.: US 2025/0291653 A1
(43) Pub. Date: Sep. 18, 2025

(54) Event Streaming For Container Orchestration System

(71) Applicant: Oracle International Corporation, Redwood Shores, CA (US)

(72) Inventors: Joshua Horwitz, Centreville, VA (US); Srinidhi Chokkadi Puranik, San Jose, CA (US); Matthew Raymond Curtis, Melbourne (AU); Akshay Kumar, Santa Clara, CA (US); Zaid Abu Ziad, Shoreline, WA (US)

(73) Assignee: Oracle International Corporation, Redwood Shores, CA (US)

(21) Appl. No.: 18/602,298

(22) Filed: Mar. 12, 2024

(51) Int. Cl. G06F 9/54; G06F 9/455; G06F 9/50

(52) U.S. Cl. CPC G06F 9/542; G06F 9/45558; G06F 9/5072; G06F 2009/45591

(57) ABSTRACT

Techniques for virtual agents for container orchestration systems are disclosed. The system deploys a pod with at least one container on a container instance. The system deploys an event stream associated with the container instance. The event stream is comprised of container events corresponding to the container instance. The system consuming the container events from the event stream is associated with the container instance. The system then updates the status of the pod based on the container events from the event stream associated with the container instance.

### TECHNICAL FIELD

The present disclosure relates to container orchestration systems. In particular, the present disclosure relates to virtual agents for container orchestration systems.

### BACKGROUND

Container orchestration is the process of automating the deployment, scaling, and management of containerized applications. Containers allow developers to package an application and its dependencies into a single unit, ensuring consistency across different environments. Container orchestration involves automating the provisioning, deployment, networking, scaling, availability, and lifecycle management of containers. Container orchestration helps to simplify the process of deploying and managing containers, especially when dealing with large-scale applications. Kubernetes is currently the most popular container orchestration platform and is widely used by leading public cloud providers.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates a system in accordance with one or more embodiments;

FIG. 7 illustrates an example set of operations for status events for virtual agent with container orchestration in accordance with one or more embodiments;

FIG. 8 illustrates an example set of operations for maintenance status events for virtual agent with container orchestration in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1 1. GENERAL OVERVIEW
2. CLOUD COMPUTING TECHNOLOGY
3. COMPUTER SYSTEM
4. VIRTUAL NODE EVENT ARCHITECTURE
5. CONTAINER EVENTS FOR VIRTUAL NODE
6. HYPER VISOR EVENTS FOR VIRTUAL NODE
7. PRACTICAL APPLICATIONS, ADVANTAGES, & IMPROVEMENTS
8. MISCELLANEOUS; EXTENSIONS

### 1. General Overview

One or more embodiments stream container and/or hypervisor events in an event stream (called a virtual node event stream) for a virtual node of a container orchestration cluster. Such a virtual node event stream allows a virtual agent to maintain the status of pods and containers of a virtual node in the container orchestration cluster. The virtual node event stream is associated with the virtual agent and with a plurality of container instances launched by the virtual agent. The virtual agent subscribes to the event stream and is alerted of container and/or hypervisor events without requiring the virtual agent to poll for such events. The virtual agent identifies the virtual node event stream to a container instance service that launched a container instance of a pod in the virtual node. The container instance service transmits the container events to the identified virtual node event stream. The system then updates the status of the pod on a container orchestration API server.

One or more embodiments deploy a pod with at least one container on a container instance. The pod is part of a virtual node in a container orchestration cluster. The container instance is a virtual machine that executes a containerized application.

One or more embodiments subscribe to the virtual node event stream associated with the container instance. The event stream includes container events corresponding to the container instance. The container events are events concerning containers on the pod. When the system restarts a container or when a container health probe state changes, a container event is sent to the virtual node event stream. The container event includes a container instance snapshot that includes container and probe state. One or more embodiments use multiple virtual agent replicas. Virtual agent replicas perform a subscribing operation to the virtual node event stream. The virtual agent updates the status of the pod based on the container events from the virtual node event stream.

One or more embodiments consume hypervisor events from the virtual node event stream. Hypervisor events concern failure or planned maintenance of a hypervisor such as a container instance. The virtual agent then updates the status of the pod based on the hypervisor events from the virtual node event stream.

One or more embodiments launches the container instances and transmits the container events corresponding to the container instance to the event stream using a container instance service. The container instance service transmits the hypervisor events corresponding to the container instance to a second event stream (hypervisor event stream), and a management plane transmits the hypervisor events corresponding to the container instance from the hypervisor event stream to the virtual node event stream.

One or more embodiments use a predefined rule that requires forwarding the hypervisor events corresponding to the container instance to the virtual node event stream. The system forwards hypervisor events from the hypervisor event stream to the virtual node event stream based on the predefined rule.

One or more embodiments described in this Specification and/or recited in the claims may not be included in this General Overview section.

### 2. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling Operating System (OS), middleware, and/or application deployment e.g., on self-service virtual machines that can be spun up on demand.

In some examples, laaS provisioning may refer to acquiring computers or virtual hosts for use and even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. In some instances, the provisioning can be done manually, a provisioning tool may be utilized to provision the resources, and/or deployment tools may be utilized to deploy the code once the infrastructure is provisioned.

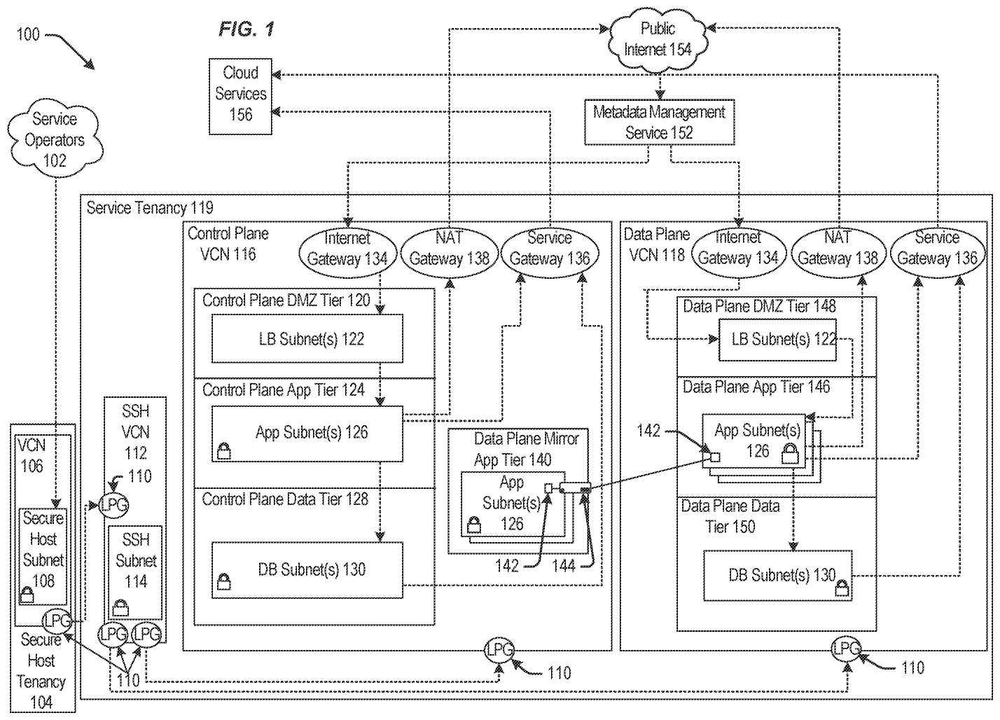

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices that may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124. The LB subnet(s) 122 may further be communicatively coupled to an Internet gateway 134 that can be contained in the control plane VCN 116. The app subnet(s) 126 can be communicatively coupled to the DB subnet(s) 130 contained in the control plane data tier 128, a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The service gateway 136 can make API calls to cloud services 156, and cloud services 156 can send requested data to the service gateway 136.

In some examples, the secure host tenancy 104 can be directly connected to the service tenancy 119 that may be otherwise isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118. The data plane mirror app tier 140 of the control plane VCN 116 can communicate with the data plane app tier 146 of the data plane VCN 118 via VNICs 142. VNICs 142 can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response to this determination, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configurations of resources contained in the data plane VCN 118.

In some embodiments, the control plane VCN 116 and the data plane VCN 118 can be contained in the service tenancy 119. The user, or the customer, of the system may be restricted from owning or operating either the control plane VCN 116 or the data plane VCN 118. Instead, the IaaS provider may own or operate the control plane VCN 116 and the data plane VCN 118, both of which may be contained in the service tenancy 119. This embodiment can enable isolation of networks that may prevent users or customers from interacting with other users' or other customers' resources. Also, this embodiment may allow users or customers of the system to store databases privately without needing to rely on public Internet 154 that may not have a desired level of threat prevention for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119 that may be isolated from public Internet 154.

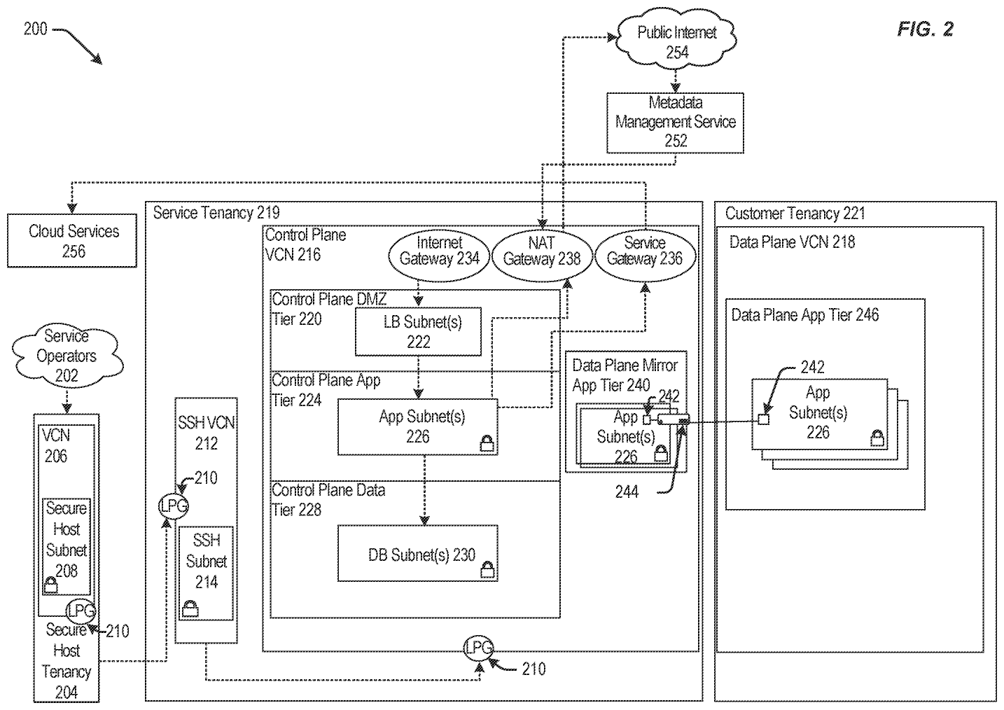

FIG. 2 is a block diagram illustrating another example pattern of an IaaS architecture 200, according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1). The Internet gateway 234 can be contained in the control plane VCN 216. Additionally, the app subnet(s) 226 can be communicatively coupled to the DB subnet(s) 230 contained in the control plane data tier 228, a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique, compute instance 244 that is contained in the service tenancy 219. Each compute instance 244 may allow communication between the control plane VCN 216, contained in the service tenancy 219, and the data plane VCN 218, contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment, or other usage of resources, of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in Region 1, and cloud service Deployment 1 may be located in Region 1 and in Region 2. If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

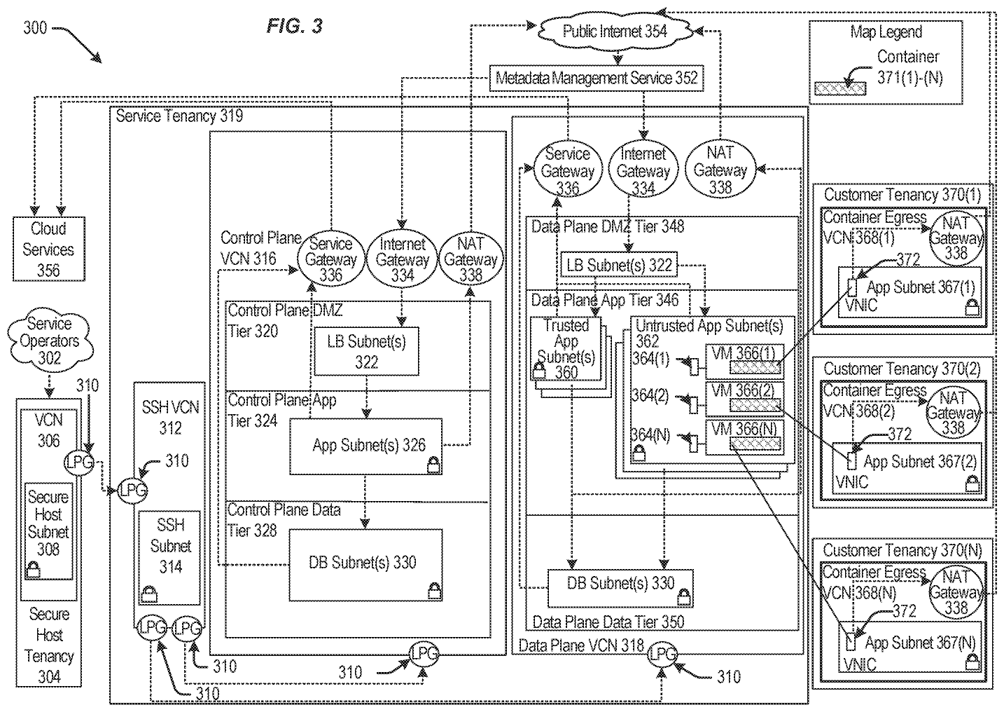

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316. Additionally, the app subnet(s) 326 can be communicatively coupled to the DB subnet(s) 330 contained in the control plane data tier 328, to a service gateway 336 (e.g., the service gateway of FIG. 1), and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360 and untrusted app subnet(s) 362 of the data plane app tier 346 and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to execute that may be destructive, may communicate with other customer resources, or may otherwise cause undesirable effects. In response to this, the IaaS provider may determine whether to execute code given to the IaaS provider by the customer.

In some examples, the customer of the IaaS provider may grant temporary network access to the IaaS provider and request a function to be attached to the data plane app tier 346. Code to execute the function may be executed in the VMs 366(1)-(N), and the code may not be configured to execute anywhere else on the data plane VCN 318. Each VM 366(1)-(N) may be connected to one customer tenancy 380. Respective containers 381(1)-(N) contained in the VMs 366(1)-(N) may be configured to execute the code. In this case, there can be a dual isolation (e.g., the containers 381(1)-(N) executing code, where the containers 381(1)-(N) may be contained in at least the VM 366(1)-(N) that are contained in the untrusted app subnet(s) 362), which may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of executing the code, the IaaS provider may kill or otherwise dispose of the containers 381(1)-(N).

In some embodiments, the trusted app subnet(s) 360 may execute code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of each customer and that may execute code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

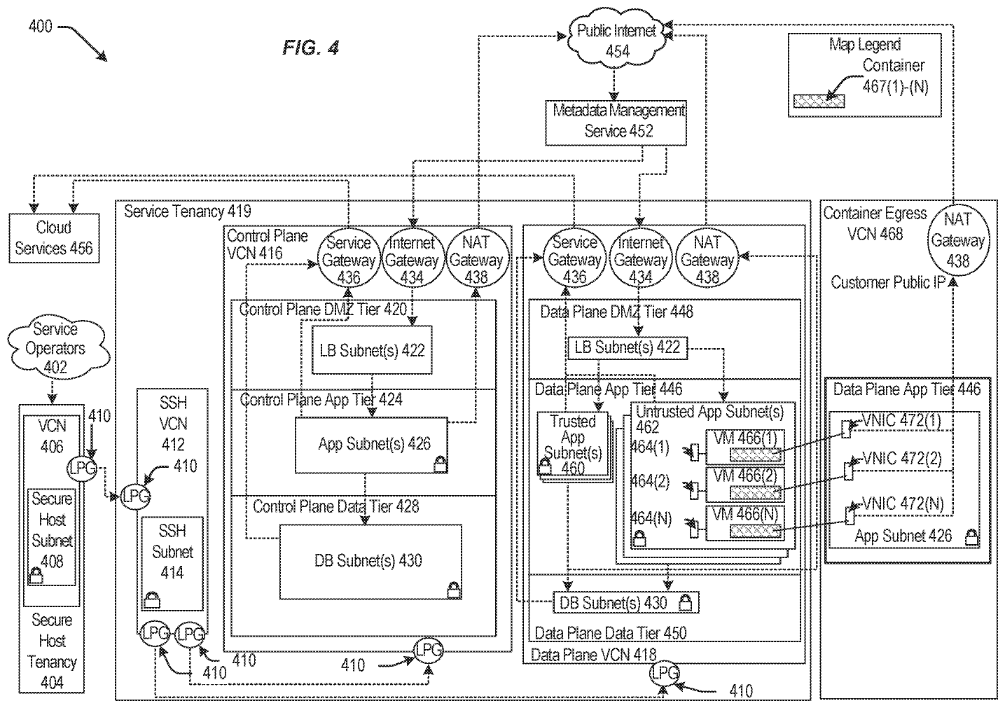

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1). The SSH VCN 412 can be communicatively coupled to a control plane VCN 416 (e.g., the control plane VCN 116 of FIG. 1) via an LPG 410 contained in the control plane VCN 416. The SSH VCN 412 can be communicatively coupled to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424. The LB subnet(s) 422 can be communicatively coupled to an Internet gateway 434 (e.g., the Internet gateway 134 of FIG. 1) that can be contained in the control plane VCN 416. The app subnet(s) 426 can be communicatively coupled to the DB subnet(s) 430 contained in the control plane data tier 428, a service gateway 436 (e.g., the service gateway of FIG. 1), and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can execute code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3. The pattern illustrated by the architecture of block diagram 400 of FIG. 4 may be implemented for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real-time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may execute code in the containers 467(1)-(N) that requests a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, 400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use the same network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset stored by the computer network is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates the tenants that have authorization to access an application. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 4. Computer System

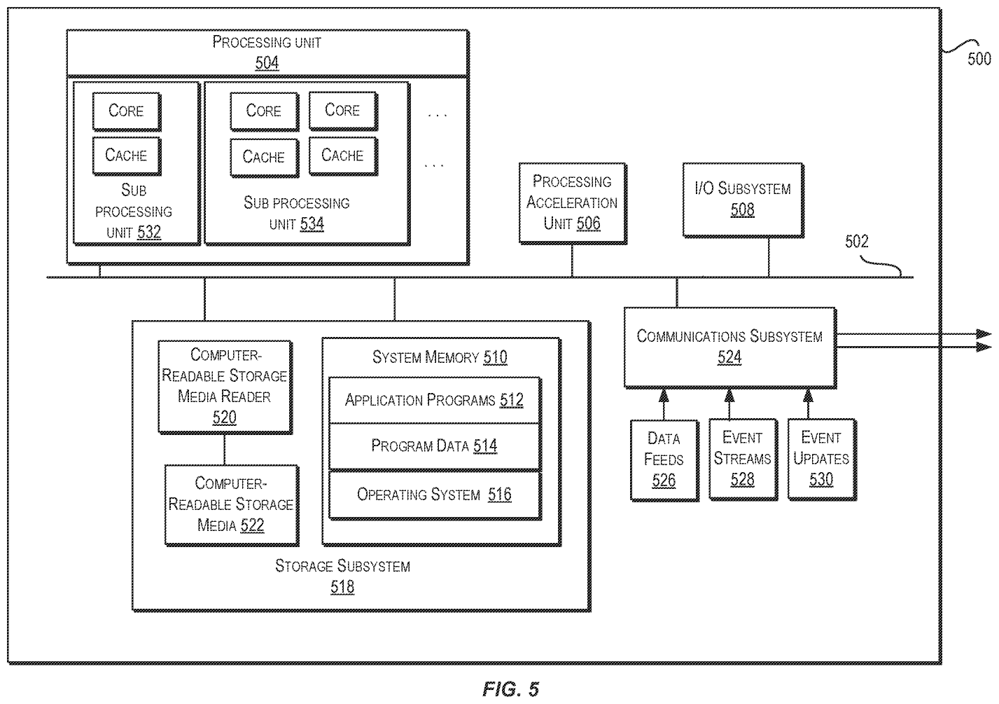

FIG. 5 illustrates an example computer system 500, where various embodiments may be implemented. The system 500 may be used to implement any of the computer systems described above. As shown in FIG. 5, computer system 500 includes a processing unit 504 that communicates with several peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. The PCI bus can be implemented as a Mezzanine bus manufactured to the IEEE P1386.1 standard.

Processing unit 504 that can be implemented as one or more integrated circuits (e.g., a conventional microprocessor or microcontroller) controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some of the program code to be executed can be resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator) through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 500 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 500 may comprise a storage subsystem 518 that provides a tangible, non-transitory, computer-readable storage medium for storing software and data constructs that provide the functionality of the embodiments described in this disclosure. The software can include programs, code modules, instructions, scripts, etc., that when executed by one or more cores or processors of processing unit 504, provide the functionality described above. Storage subsystem 518 may also provide a repository for storing data used in accordance with the present disclosure.

As depicted in the example in FIG. 5, storage subsystem 518 can include various components including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various different kinds of programs may be loaded into system memory 510 including but not limited to client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations, where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500 including instructions executable by processing unit 504 of computer system 500.

Computer-readable storage media 522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 524 may also be configured to receive data in the form of continuous data streams that may include event streams 528 of real-time events and/or event updates 530 that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended only as a specific example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. Virtual Node Event Architecture

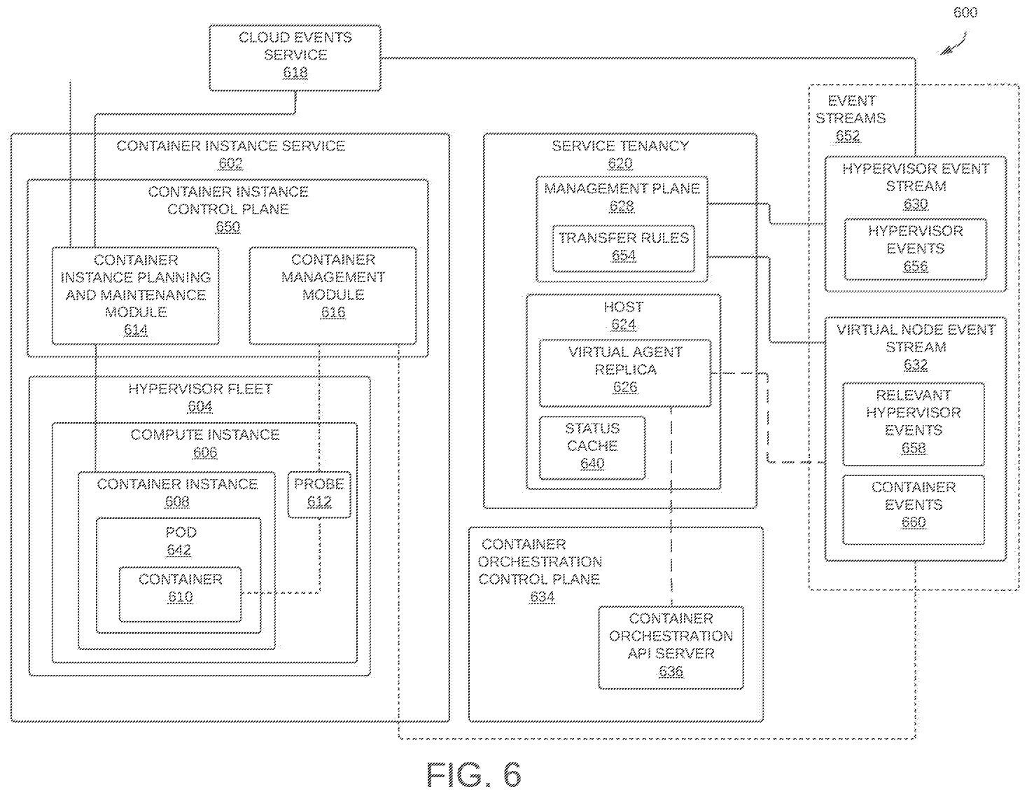

In one or more embodiments, system 600 may include more or fewer components than the components illustrated in FIG. 6. The components illustrated in FIG. 6 may be local to or remote from each other. The components illustrated in FIG. 6 may be implemented in software and/or hardware. Components may be distributed over multiple applications and/or machines. Multiple components may be combined into one application and/or machine. Operations described with respect to one component may instead be performed by another component.

FIG. 6 illustrates a system 600 in accordance with one or more embodiments. As illustrated in FIG. 6, system 600 includes container instance service 602, hypervisor fleet 604, compute instance 606, container instance 608, container 610, probe 612, container instance planning and maintenance module 614, container management module 616, cloud events service 618, service tenancy 620, host 624, virtual agent replica 626, management plane 628, event streams 652, hypervisor event stream 630, virtual node event stream 632, hypervisor events 656, relevant hypervisor events 656, container events 660, container orchestration control plane 634, container orchestration API server 636, status cache 640, container instance control plane 650 and pod 642.

In accordance with an embodiment, a container orchestration system provides a runtime for containerized workloads and services. Examples of container orchestration systems include Kubernetes and Docker Swarm.

In accordance with an embodiment, a container orchestration implementation provider is an implementation provider for a particular type of container orchestration system. Examples of container orchestration implementations include Oracle Container Engine for Kubernetes (OKE) and Amazon Elastic Kubernetes Service (EKS); both provide container orchestration implementations (i.e., are vendors) for Kubernetes.

In accordance with an embodiment, a container orchestration node is a virtual or physical machine in a container orchestration cluster. A control plane manages the container orchestration nodes and contains the services necessary to execute containers or pods. For a Kubernetes cluster, the container orchestration node is a Kubernetes node. Components on a container orchestration node in Kubernetes include a kubelet, a container runtime, and a kube-proxy. A container orchestration node is an individual bare metal machine or virtual machine (VM), where containers execute within a container orchestration environment, for example, as part of a Kubernetes cluster or Docker Swarm instance.

In accordance with an embodiment, a container orchestration agent executes on container orchestration nodes and is responsible for communications between the container orchestration control plane and the node where the workload executes. In Kubernetes, the container orchestration agent is a kubelet.

In accordance with an embodiment, a virtual node is a container orchestration node implemented on multiple hosts, computers, or devices. A virtual agent is a container orchestration agent for a virtual node. The virtual agent interacts with containers, such as containers in pods 642 at container instance 608. The virtual agent and the containers execute at separate locations within the virtual node.

In accordance with an embodiment, virtual agent replica 626 is a replica of a virtual agent for a virtual node. Multiple virtual agent replicas allow the virtual node to operate in a high availability manner. Virtual agent replicas executing on different hosts in different fault domains provide for high availability for the virtual agent and virtual node. For example, if virtual agent replica 626 fails, another virtual agent replica (not shown) maintains operation in the virtual node. Virtual agents provide customers with the ability to deploy containerized applications without having to manage the data plane infrastructure. Thus, the virtual agent reduces the operational burden on the customer.

In accordance with an embodiment, a container instance, such container instance 608, is a virtual machine that executes a containerized application in a cloud system. A container instance provides the benefits of a traditional VM instance, such as Central Processor Unit (CPU) and memory resources. The container instance uses a standardized and/or reduced functionality for containers. In FIG. 6, container instance 608 includes pod 642 with container 610.

In accordance with an embodiment, pods, such as pod 642, execute containers scheduled on a virtual node. A Kubernetes pod is a group of one or more containers with shared storage and network resources and a specification for how to execute the containers. In FIG. 6, container 610 is part of a single virtual node along with virtual agent replica 626.

In accordance with an embodiment, control plane APIs create a virtual node pool, defined as a collection of virtual nodes including virtual agents. Customers interact with the container orchestration cluster using container orchestration API server 636. Customers create pods, such as pod 642, for a virtual node by storing an update using container orchestration API server 636. The virtual agent of the virtual node obtains information from container orchestration API server 636 and provision containers for the pod, such as pod 642, at container instances, such as container instance 608. Customers also retrieve logs from a pod using the virtual agent.

In accordance with an embodiment, the virtual agent generates a container instance, such as container instances 608, for pod 642 scheduled on the virtual node. A service tenancy executes container instance 608. Container instance 608 is not visible to customers, but the customer network connects to container 610 in container instance 608. For example, customers access applications executing in a pod of a container instance using the pods IP address in the customer network.

In accordance with an embodiment, the virtual agents, such as virtual agent replica 626, use credentials provided by a management plane 628. The provided certificates include a client certificate to communicate with container orchestration API server 636 for registering nodes, updating node status, retrieving pod information, and updating pod status; as well as a server certificate. The system provides the virtual agent with a server certificate, signed by cluster certificate authority. This verifies this certificate to ensure that the server certificate is signed by cluster certificate authority to establish trust. The management plane also provides the virtual agent with a client certificate signed by the cluster certificate authority.

In accordance with an embodiment, a network proxy performs stream forwarding and includes other functionality, such as filtering content, scanning for malware, masking the origin of the requests, and encryption. A Kubernetes network kube-proxy executes on the Kubernetes nodes and includes functionality for simple TCP, UDP, and SCTP stream forwarding or round robin TCP, UDP, and SCTP forwarding. Kube-proxy routes traffic headed to container orchestration service endpoints.

In one embodiment, a virtual node uses multiple container instances in different locations, so multiple kube-proxies are used in a single virtual node, and container instances contain a kube proxy as a sidecar. Containers in a container instance share the same network namespace and, in that case, two containers in a container instance cannot use the same port.

In accordance with an embodiment, the system accesses applications deployed to a cluster using service endpoints. A service endpoint allows resources within a cloud network to privately connect to a service using private IP addresses. A private connection occurs over the cloud network, bypassing the public internet.

In one embodiment, a Kubernetes service is a Kubernetes resource that exposes application pods behind an IP address (and cluster local Domain Name System (DNS) endpoint). This endpoint is recognized by kube-proxy. Traffic to this endpoint is also load balanced by kube-proxy. Kube-proxy discovers IP addresses of healthy pods corresponding to a service via the cluster's container orchestration API server and updates the Internet Protocol (IP) table on the container instances to load balance traffic to the service endpoint to healthy pods. The container orchestration API Server receives the status of pods from kubelets executing on nodes. Virtual agents of the virtual nodes update the status of pods from kubelets executing on nodes.

In accordance with an embodiment, container orchestration control plane 634 acts as the control plane for a container orchestration cluster. In Kubernetes, a Kubernetes control plane makes global decisions about the cluster including scheduling as well as detecting and responding to cluster events (for example, starting up a new pods).

In accordance with an embodiment, container orchestration API server 636 exposes an API to allow users to control the cluster. In Kubernetes, the Kubernetes API server is a component of the Kubernetes control plane that exposes the Kubernetes API and is the front end for the Kubernetes control plane. The Kubernetes API is a resource-based (RESTful) programmatic interface provided via the Hypertext Transfer Protocol (HTTP). The Kubernetes API supports retrieving, creating, updating, and deleting primary resources via the standard HTTP verbs (POST, PUT, PATCH, DELETE, GET).

In accordance with an embodiment, container instance control plane 650 is a layer that manages tasks for container instances. Container instance control plane 650 configures network devices, allocates IP addresses, manages network security, and creates and distributes routing policies. In accordance with an embodiment, container instance control plane 650 includes container instance and maintenance module 614 and container management module 616.

In accordance with an embodiment, container management module 616 receives information concerning containers, such as container 610, from probes such as probe 612, and forwards container events 660 to the appropriate virtual node event stream such as virtual node event stream 632.

In accordance with an embodiment, container instance and maintenance module 614 monitors container instances, such as container instance 608, and produces hypervisor events sent to cloud events service 618. Container instance and maintenance module 614 also receives planned maintenance actions from a user and produces hypervisor events for the planned maintenance events. An exemplary planned maintenance event indicates that container instance 608 will be shut down at a certain time.

In one or more embodiments, container instance service 602 launches and maintains container instances such as container instance 608. Container instance service 602 includes container instance control plane 650 and a hypervisor fleet 604 of container instances, such as container instance 608, executing on compute instance 606.

In one or more embodiments, hypervisor fleet 604 includes multiple container instances executing on compute instances.

In one or more embodiments, compute instance 606 is a host that executes the container instances. The compute instances are placed in different fault domains to allow for high availability and recovery of container instances. Compute instance 606 includes a probe 612 to monitor the containers in the container instances of the compute instance.

In accordance with an embodiment, event streams 652 are a continuous flow of data, where the data represents an event or a change of state. Examples of events are a customer logging into a service, an inventory update at a distribution center, or the completion of a payment transaction. In an event-driven architecture, services publish streams of data as events, and other services subscribe to these streams. An event triggers one or more actions or processes in response. In an event-driven architecture, instead of asking other services for their current state (as in a conventional architecture), services continuously publish events, and subscribers process these events locally. When a specific type of event occurs, the relevant service acts accordingly. Event streaming involves processing data in real-time, and the resulting actions depend on the type of data and the nature of events.

An example of an event streaming architecture is Apache Kafka. Apache Kafka is a distributed event store and stream-processing platform. Apache Kafka connects to external systems (for data import/export) via Kafka Connect and provides the Kafka Streams libraries for stream processing applications. Kafka uses a binary TCP-based protocol optimized for efficiency and relies on a “message set” abstraction that naturally groups messages together to reduce the overhead of the network roundtrip. Apache Kafka uses larger network packets, larger sequential disk operations, and contiguous memory blocks that allow Kafka to turn a bursty stream of random message writes into linear writes.

In accordance with an embodiment, a stream is a continuous, unbounded series of events. These events represent important actions or occurrences within a software domain. Events in the stream carry a timestamp denoting when the event occurred. The system orders events within the stream based on the event's timestamps.

In accordance with an embodiment, a stream is a partition of a larger stream. Event streaming platforms, like Apache Kafka, organize data into topics that are a stream of events related to a specific domain or category. In one embodiment, topics have one or more partitions, or sub-streams.

In accordance with an embodiment, virtual node event stream 632 is a stream subscribed to by a virtual agent, such as virtual agent replica 626, for events related to pods of the virtual node. The events include container events 660 concerning containers of a virtual node, such as container 610 in pod 642, and relevant hypervisor events 658 concerning failure or planned maintenance of a hypervisor such as container instance 608.

In accordance with an embodiment, for containers in a virtual node, when a container is restarted or a container health probe state changes, the system sends a container event, such as one of container events 660, to the virtual node event stream 632. In accordance with an embodiment, container events 660 includes a container instance snapshot, including container and probe state. Container instance service 602 sends container events 660 related to the containers of a virtual node to virtual node event stream 632.

In one or more embodiments, probe 612 monitors the containers in the container instances of the compute instance and produces information or container events 660 concerning the containers. Container events 660 are events concerning containers of a virtual node such as container 610 in pod 642. In one embodiment, whenever the system restarts a container or the container health changes, probe 612 produces a container event as part of a container instance snapshot. Container management module 616 sends a container event from probe 612 to the virtual node event stream 632.

In accordance with an embodiment, the system also sends relevant hypervisor events 658 to virtual node event stream 632. Container instance service 602 sends relevant hypervisor events 658 to cloud events service 618. Container instance service 602 emits hypervisor events when the container instance (hypervisor) fails. Container instance service 602 also creates hypervisor events for planned maintenance events for the container instances.

In one or more embodiments, cloud event service 618 receives the hypervisor events as cloud events and then sends the cloud events to the correct stream such as hypervisor event stream 630.

In accordance with an embodiment, management plane 628 configures and manages parts of the system including virtual agent replicas. In one or more embodiments, management plane 628 subscribes to hypervisor event stream 630.

In accordance with an embodiment, hypervisor event stream 630 includes hypervisor events 656 for multiple virtual nodes. Management plane 628 forwards relevant hypervisor events 658 related to a virtual agent, such as virtual agent replica 626, to virtual node event stream 632. For example, management plane 628 sends relevant hypervisor events 658 for the container instances that have containers in a virtual node to a virtual node event stream for that virtual node. In one example, management plane 628 uses an event distributor to redistribute hypervisor events to the virtual agent's event stream.

In accordance with an embodiment, transfer rules 654 are used by management plane 628 to forward the relevant hypervisor events 658 corresponding to virtual agent replica 626 (and container instance 608) to virtual node event stream 632. Management plane 628 forwards the relevant hypervisor events 658 corresponding to virtual agent replica 626 from hypervisor event stream 630 to virtual node event stream 632 based on the predefined rule. Transfer rules 654 may include a rule of the form “For ANY event of TYPE container instance hypervisor failure” DO “Redirect to the specified stream.”

In accordance with an embodiment, management plane 628 ensures that virtual agents execute the right version using a transparent upgrade. The management plane implements a rolling upgrade of virtual agent replica 626 without any downtime to customers. The upgrades include upgrades necessitated by container orchestration version upgrade. Customers trigger a container orchestration version upgrade on a cluster using a control plane API to automatically upgrade the virtual agents in the cluster if required. The upgrades also include routine bug fixes and enhancements deployed automatically in the background.

In one or more embodiments, status cache 640 stores the status of the pods and containers of the virtual node by the virtual agent replica 626 as indicated by container events 660 and the relevant hypervisor events 658. Virtual agent replica 626 also updates container orchestration API server of the status changes.

In accordance with an embodiment, a tenancy is a secure and isolated partition within a cloud system, where a tenant creates, organizes, and administers cloud resources. A tenancy is a hierarchical collection of compartments, where the root compartment is the tenancy. A tenant, or customer, is a party with a tenancy in the cloud system. A cloud network manager is a manager for one or more tenants or customers in a cloud network. In one example, the cloud network manager is an owner or renter of the cloud network.

In accordance with an embodiment, service tenancies, such as service tenancy 620, are tenancies under the control of the cloud network manager. Components in service tenancies, such as virtual agents (virtual agent replica 626), are version patched under the control of the cloud network without requiring a request from the customer. In addition, the components in the service tenancies are protected using cloud network security.

In accordance with an embodiment, customer tenancy is a tenancy under the control of the customer. Customer tenancy contains a customer network such as a customer network for a container orchestration cluster. In FIG. 6, service tenancies and customer tenancies are implemented within the same cloud environment and configured to execute operations corresponding to a data set associated with the customer. For example, the data set defines a container orchestration cluster, such as a Kubernetes cluster.

In accordance with an embodiment, host 624 is a separate computer or device that connects to the network. In one example, host 624 is in a different fault domain from other hosts that implement one of the virtual node replicas.

In accordance with an embodiment, a fault domain is a group of nodes that share physical infrastructure. In one example, a particular node is associated with one more fault domains. Examples include regions (e.g., a geographical area, such as a city), availability zones (partitioning within a region with dedicated power and cooling), or other fine-grained partitioning of a physical infrastructure (e.g., a semi-isolated rack within a data center).

In one or more embodiments, a data repository stores the data and configuration of system 600. The data repository is any type of storage unit and/or device (e.g., a file system, database, collection of tables, or any other storage mechanism) for storing data. Alternatively, a data repository includes multiple different storage units and/or devices. The multiple different storage units and/or devices may or may not be of the same type or located at the same physical site. Alternatively, a data repository is implemented or executed on the same computing system as system 600. Additionally, or alternatively, a data repository is implemented or executed on a computing system separate from system 600. The data repository is communicatively coupled via a direct connection or via a network. Information describing system 600 may be implemented across any of the components within the system 600.

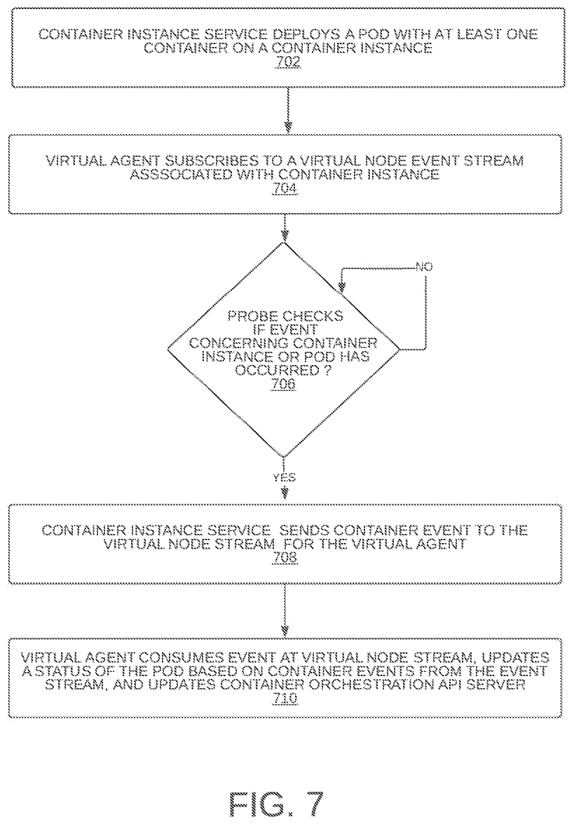

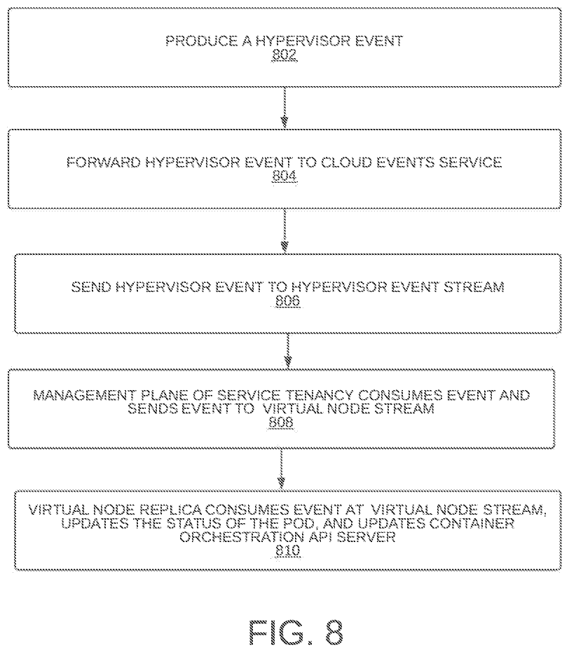

In one or more embodiments, container instance service 602, hypervisor fleet 604, compute instance 606, container instance 608, container 610, probe 612, container instance and maintenance module 614, container management module 616, cloud event service 618, service tenancy 620, host 624, virtual agent replica 626, management plane 628, event streams 652, hypervisor event stream 630, virtual node event stream 632, hypervisor events 656, relevant hypervisor events 656, container events 660, container orchestration control plane 634, container orchestration API server 636, status cache 640, container instance control plane 650, and pod 642 refers to hardware and/or software configured to perform operations described herein for container orchestration. Examples of operations for container orchestration are described below with reference to FIGS. 7 and 8.

In an embodiment, container instance service 602, hypervisor fleet 604, compute instance 606, container instance 608, container 610, probe 612, container instance and maintenance module 614, container management module 616, cloud event service 618, service tenancy 620, host 624, virtual agent replica 626, management plane 628, event streams 652, hypervisor event stream 630, virtual node event stream 632, hypervisor events 656, relevant hypervisor events 656, container events 660, container orchestration control plane 634, container orchestration API server 636, status cache 640, container instance control plane 650 and pod 642 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 5. Container Events for Virtual Node

FIG. 7 illustrates an example set of operations for container events for virtual nodes in accordance with one or more embodiments. One or more operations illustrated in FIG. 7 may be modified, rearranged, or omitted. Accordingly, the particular sequence of operations illustrated in FIG. 7 should not be construed as limiting the scope of one or more embodiments.

In an embodiment, the container instance service deploys a pod with at least one container executing on a container instance (Operation 702). A virtual agent instructs the container instance service to deploy the pod with the container based on a specification from a container orchestration API server.

In one embodiment, when a pod is scheduled on a virtual node, the virtual agent launches a container instance to execute the pod using the container service. The state of the pod is dependent on the state of the container instance that executes the pod. Therefore, the system periodically fetches the status of the container instances backing the pods scheduled on it. The system subsequently determines the status of the pods and reports the status to the container orchestration API Server, so the pod object in the container orchestration cluster has the accurate pod status.

In an embodiment, the virtual agent subscribes to the virtual node event stream associated with the container instance (Operation 704). The virtual node event stream comprises events, such as a container events and hypervisor events.

In one embodiment, a management plane creates one stream per virtual node and passes stream details to the virtual agent during creation. When a pod is scheduled on a virtual node, the virtual agent specifies the virtual node event stream as part of the create container request sent to the container instance service. The container instance service then sends container and hypervisor events to the virtual node event stream.

In one embodiment, on startup, the virtual agent calls the container instance control plane to get a list of container instances and maps the container instances to the corresponding pods. During creation of a container instance, the system may assign the container instance a tag. The system may map using the tag on the container instance to form the initial cache of the container instances to pods mapping. The virtual agent starts a background job to periodically list container instances and clean up container instances without a corresponding pod. The virtual agent builds the initial status of the pods and determines the stream checkpoint. The virtual agent then creates a stream consumer to start consuming messages from the stream after the checkpoint.

In an embodiment, a probe checks if a container event concerning container instance or pod has occurred (Operation 706). Whenever the system restarts a container or the container health changes, the probe produces a container event as part of a container instance snapshot including container and probe state. The system sends the container event to the stream. The container instance service feeds the container instance snapshots to a stream configured for the virtual agent whenever there are container instance state updates.

In an embodiment, the management plane of container instance service sends events to the virtual node event stream for the relevant virtual node (Operation 708). In one embodiment, the container instance service serves events to the virtual node event stream, including container events and hypervisor events, for the container instance. In one example, the container event includes a container instance snapshot, including container and probe state to the stream.

In an embodiment, the probe sends container events to a container management module in the container instance control plane. The container management module forwards the container event to the virtual node event stream.

In one example, the container instance service sends messages containing a snapshot of the entire container instance state to the virtual node event stream. The snapshot includes the container instance identifier, container state, container probe state, container stats like restartCount (RestartCount represents the number of times the container inside a pod has been restarted), etc. In addition, the container instance service sends events triggered by hypervisor failures that result in container instance failure to cloud events.

In an embodiment, the system enables defining rules to redirect these events to a specified stream. The messages from this stream are consumed and applied to the pod status via the container orchestration API server.

In one embodiment, endpoint probes watch for cloud and container instance control plane outages. When either probe fails (after preconfigured retries and interval), the virtual agent leader relinquishes the lease, and as a result, the virtual agent reaches a not ready state. During an outage, when the percentage of unhealthy nodes breaches a threshold, the system suspends pod eviction to ensures that pods are not evicted during an outage.

In an embodiment, the virtual agent status replica consumes event at virtual node event stream partition, updates a status of the pod based on container events from the event stream, and updates container orchestration API server (Operation 710). Virtual agents are responsible for updating the status of the pods scheduled on it.

In one embodiment, the virtual agent consumes messages from the stream and updates the memory cache of the container instance states. Using the cache, the virtual agent determines the pod statuses and reports the pod statuses to the container orchestration API server periodically. In one example, the virtual agent includes multiple virtual agent replicas that maintain a cache of status events. Using the information in the cache, the virtual agent leader periodically determines the status of the pods scheduled on it and reports the status to the container orchestration API server.

### 6. Hypervisor Events for Virtual Node

FIG. 8 illustrates an example set of operations for hypervisor events for virtual nodes in accordance with one or more embodiments. One or more operations illustrated in FIG. 8 may be modified, rearranged, or omitted. Accordingly, the particular sequence of operations illustrated in FIG. 8 should not be construed as limiting the scope of one or more embodiments.

In an embodiment, the container instance service produces a hypervisor event (Operation 802). The hypervisor event may indicate the failure of a container instance or planned maintenance on the container instance.

In one embodiment, the container instance service produces hypervisor events when the container instance (hypervisor) fails. The container instance moves to failed state, and the container instance server sends a cloud event to the stream.

In one embodiment, the system uses periodic container events that are emitted during a fixed period, such as once per 60 secs, to determine hypervisor failure. After receiving a container event for a container instance, if the virtual agent does not receive the next periodic event within a fixed period, such as 300 secs, the virtual agent polls the container instance control plane to determine the state of the container instance. If the container instance is in a DELETED state, the virtual agent evicts the corresponding pod. Alternatively, the container instance service determines hypervisor failure events without being prompted by the virtual agent.

In one embodiment, the container instance service creates hypervisor events for maintenance events indicated to the container instance service. The container instance service receives planned maintenance actions from a user and produces hypervisor events for the planned maintenance events. An example planned maintenance event indicates that container instance will shut down at a given time.

In an embodiment, the container instance service forwards hypervisor event to a cloud events service (Operation 804). When the container instance service suffers from a hypervisor failure, the container instances launched by a virtual agent fails. The container instance service emits cloud events concerning the hypervisor failure to the cloud events service. The container instance service also sends hypervisor events related to a planned maintenance event to the cloud events service.

In an embodiment, the cloud events service sends the hypervisor event to hypervisor event stream (Operation 806). In one embodiment, the system uses a single hypervisor stream that virtual agents share for the hypervisor events. In one example, the system uses a single event rule of the form “For ANY event of TYPE container instance hypervisor failure” DO “Redirect to the specified stream”. The management plane may create the hypervisor stream during startup if the hypervisor event stream does not exist already.

In an embodiment, the management plane of a service tenancy consumes the hypervisor event and sends the hypervisor event to a virtual node event stream (Operation 808). In one embodiment, when the virtual agents share a single stream for hypervisor events, the management plane uses an event distributer to redistribute hypervisor events to the virtual node event streams. In one example, the hypervisor events include a virtual agent identifier tag passed to the container instance during creation.

In one embodiment, the management plane uses transfer rules to redirect a virtual agent's hypervisor events to the stream with the virtual agent's container events. In one example, the management plane uses transfer rules such as: “For ANY event of TYPE container instance Hypervisor Failure AND tag stream identifier” DO “Redirect to the relevant stream”.

In one embodiment, the system creates the hypervisor event stream and event rule at a tenancy level. The customer triggers virtual agent creation through the control plane. The management plane creates the virtual node event stream for the virtual agent. The management plane launches the virtual agent and passes the virtual agent identifier to the virtual agent as a tag. The management plane maintains a record of the stream identifier allocated to the virtual agent. The system uses the record to map the virtual agent identifier to stream identifier.

In an embodiment, a virtual node replica consumes event at the virtual node event stream, updates the status of the pod, and updates container orchestration API server (Operation 810). The virtual agent reads hypervisor and/or container events from the stream. In one embodiment, the virtual agent reads events from the virtual node event stream. The virtual agent then updates the corresponding pod statuses. For hypervisor maintenance events, the virtual agent evicts the corresponding pods.

### 7. Practical Applications, Advantages, & Improvements

The use of the virtual node event streams for a virtual node of a container orchestration system has several advantages. Virtual node streams reduce the overhead of continuously checking for updates or changes. Instead of constantly querying a server or a data source, streams allow data to be pushed to the virtual agent when the event is available, reducing the need for frequent polling requests. Virtual node streams enable real-time updates, providing for a more responsive and interactive operation. Virtual node streams reduce system latency compared to polling, where the system waits for the next polling interval to receive updates. Virtual node streams are more resource-efficient compared to polling, for the virtual node stream reduces the number of unnecessary requests and server load. Virtual node streams also simplify the overall architecture by removing the need for complex polling logic and timers.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
deploying a pod with at least one container on a container instance;
subscribing to an event stream associated with the container instance, the event stream comprising container events corresponding to the container instance;
consuming the container events from the event stream associated with the container instance; and
updating a status of the pod based on the container events from the event stream associated with the container instance.

2. The non-transitory media of claim 1, wherein the event stream further comprises hypervisor events corresponding to the container instance, and wherein the operations further comprise:
consuming the hypervisor events from the event stream; and
updating the status of the pod based on the hypervisor events from the event stream.

3. The non-transitory media of claim 2, wherein a container instance service that launched the container instance transmits the container events corresponding to the container instance to the event stream, and the container instance service transmits the hypervisor events corresponding to the container instance to a second event stream, and a management plane transmits the hypervisor events corresponding to the container instance from the second event stream to the event stream.

4. The non-transitory media of claim 3, wherein a predefined rule requires forwarding of the hypervisor events corresponding to the container instance to the event stream, and the hypervisor events corresponding to the container instance are forwarded from the second event stream to the event stream based on the predefined rule.

5. The non-transitory media of claim 2, wherein at least some of the hypervisor events correspond to planned maintenance of the container instance.

6. The non-transitory media of claim 1, wherein subscribing to the event stream associated with the container instance comprises subscribing to a stream partition, of the event stream, associated with the container instance.

7. The non-transitory media of claim 1, wherein the event stream is associated with a virtual agent, and the event stream is associated with a plurality of container instances launched by the virtual agent including the container instance, and the subscribing operation is performed by the virtual agent.

8. The non-transitory media of claim 7, wherein the updating operation is also performed by the virtual agent.

9. The non-transitory media of claim 7, wherein the virtual agent includes multiple virtual agent replicas, wherein the subscribing operation is performed by the virtual agent replicas.

10. The non-transitory media of claim 7, wherein the virtual agent identifies the event stream to a container instance service that launched the container instance, and the container instance service transmits the container events to the identified event stream.

11. The non-transitory media of claim 1, wherein the status of the pod is updated on a container orchestration API server.

12. The non-transitory media of claim 1, wherein the container instance comprises a virtual machine that executes a container.

13. A method comprising:
deploying a pod with at least one container on a container instance;
subscribing to an event stream associated with the container instance, the event stream comprising container events corresponding to the container instance;
consuming the container events from the event stream associated with the container instance; and
updating a status of the pod based on the container events from the event stream associated with the container instance,
wherein the method is performed by at least one device including a hardware processor.

14. The method of claim 13, wherein the event stream further comprises hypervisor events corresponding to the container instance, and wherein the operations further comprise:
consuming the hypervisor events from the event stream; and
updating the status of the pod based on the hypervisor events from the event stream.

15. The method of claim 14, wherein a container instance service that launched the container instance transmits the container events corresponding to the container instance to the event stream, and the container instance service transmits the hypervisor events corresponding to the container instance to a second event stream, and a management plane transmits the hypervisor events corresponding to the container instance from the second event stream to the event stream.

16. The method of claim 15, wherein a predefined rule requires forwarding of the hypervisor events corresponding to the container instance to the event stream, and the hypervisor events corresponding to the container instance are forwarded from the second event stream to the event stream based on the predefined rule.

17. The method of claim 14, wherein at least some of the hypervisor events correspond to planned maintenance of the container instance.

18. The method of claim 13, wherein subscribing to the event stream associated with the container instance comprises subscribing to a stream partition, of the event stream, associated with the container instance.

19. The method of claim 13, wherein the event stream is associated with a virtual agent, and the event stream is associated with a plurality of container instances launched by the virtual agent including the container instance, and the subscribing operation is performed by the virtual agent.

20. A system comprising:
at least one device including a hardware processor;
the system being configured to perform operations comprising:
deploying a pod with at least one container on a container instance;
subscribing to an event stream associated with the container instance, the event stream comprising container events corresponding to the container instance;
consuming the container events from the event stream associated with the container instance; and
updating a status of the pod based on the container events from the event stream associated with the container instance.
